(19) United States
(12) Patent Application Publication
(10) Pub. No.: US 2025/0279220 A1
(43) Pub. Date: Sep. 4, 2025

(54) INSULATED WIRES

(71) Applicant: SOLVAY SPECIALTY POLYMERS USA, LLC, Alpharetta, GA (US)

(72) Inventors: Victoria Lee, Collingswood, NJ (US); Jason Rich, Roswell, GA (US); Mohammad Jamal El-Hibri, Atlanta, GA (US)

(73) Assignee: SOLVAY SPECIALTY POLYMERS USA, LLC, Alpharetta, GA (US)

(21) Appl. No.: 18/547,482

(22) PCT Filed: Feb. 21, 2022
(86) PCT No.: PCT/EP2022/054207

§ 371 Date: Aug. 22, 2023

Related U.S. Application Data
(60) Provisional application No. 63/152,009, filed on Feb. 22, 2021.

(30) Foreign Application Priority Data
May 4, 2021 (EP) 21171941.4

(51) Int. Cl. H01B 3/30; C08K 3/34; C08L 61/34; H02K 3/30

(52) U.S. Cl. CPC H01B 3/307; C08K 3/346; C08L 61/34; H01B 3/301; H01B 3/308; H02K 3/30; C08K 2201/003; C08L 2203/202

(57) ABSTRACT

The invention relates to wires, in particular magnet wires, comprising a thermoplastic insulation. In particular it relates to wires comprising a thermoplastic insulation comprising a polyaryletheretherketone composition in the absence of any adhesive layer.

The present application claims the priority of provisional application U.S. 63/152,009 filed on 22 Feb. 2021 and European patent application EP 21171941.4 filed on 4 May 2021, the content of which being entirely incorporated herein by reference for all purposes. In case of any incoherency between the present application and the PCT application that would affect the clarity of a term or expression, it should be made reference to the present application only.

### TECHNICAL FIELD

The invention relates to wires, in particular magnet wires, comprising a thermoplastic insulation. In particular it relates to wires comprising a thermoplastic insulation of a polyaryletheretherketone composition in the absence of any adhesive layer.

### BACKGROUND ART

Magnet wires are more and more used in electric vehicles since they are present in e.g. inverter drive motors, motor starter generators, transformers, etc. Typically, a magnet wire is constructed by applying electrical insulation to a metallic conductor, such as a copper, aluminum, or alloy conductor. The insulation provides for electrical integrity and prevents shorts in the magnet wire. Conventional insulation often consists of polymeric enamel films that are applied in successive layers and baked in a furnace. In order to achieve higher dielectric strengths and partial discharge performance to satisfy increasing electrical performance criteria, it is typically necessary to apply a greater number of layers and, therefore, thicken the enamel. However, each successive pass through the baking furnace lowers the adhesive force between the enamel and the conductor, and it is difficult to build the enamel thickness beyond a certain point. Additionally, increased enamel layering may lead to solvent blisters or beading and/or reduced flexibility.

Recently, attempts have been made to form magnet wire insulation from extruded thermoplastic materials. The thermoplastic insulation is either extruded over a bare conductor or a conductor having enamel insulation. For example, U.S. Pat. No. 9,224,523 describes a magnet wire in which polyetheretherketone (“PEEK”) is extruded over an enamel layer. Similarly, U.S. Pat. No. 9,324,476 describes a magnet wire in which either PEEK or polyaryletherketone is extruded over an enamel layer.

EP 3642283 (WO 2018/234116) discloses a layered structure comprising a polymeric layer and a varnish layer. There is no disclosure of a composition having a melt viscosity as claimed.

EP 0182580 discloses a polymer composition comprising a composition of polyaryletherketone and talc. There is no disclosure of a wire with the composition in direct contact with the conductor.

WO 2014/085083 discloses an insulating layer with PEEK. There is no disclosure of a proportion of filler.

EP 2900470 (WO 2014/052801) does not disclose any viscosity as claimed.

WO 2016/120592 discloses an insulating layer but there is no disclosure of the subject-matter of claim 1.

### Technical Problem to be Solved

When relatively high performance thermoplastic polymers are used, an adhesive layer is often required between the thermoplastic insulation and the conductor or an underlying enamel layer in order to provide proper interlayer adhesion. Accordingly, there is an opportunity for improved insulated magnet wire, and more particularly, improved magnet wire that includes thermoplastic insulation in the absence of any adhesive layer and/or an enamel layer.

The magnet wire needs to be flexible enough to ensure a good windability.

Yet, the adhesion between the insulating film and the conductor needs to be sufficient, notably when the wire is subject to a processing such as bending and stretch where peeling is likely to occur between the insulating film and the conductor. If a void occurs between the conductor and the insulating film by this peeling, the electric field concentrates there and dielectric breakdown occurs, or the stress concentrates there and the insulating film tends to easily break.

Due to this improvement in the output of the motor of electric vehicles, the amount of heat generated tends to increase and the temperature of the motor increases. Therefore, the adhesion needs to be maintained at high temperatures.

There is therefore the need of a wire that combines a good windability and a strong adhesion, in particular a strong adhesion after processing of the wire and at high temperatures.

In the case of square or rectangular-shaped wires, additional problems may be encountered. Indeed, the stresses on corners and edges can be greater on these wires than for round wires. It may also be difficult to obtain the same thickness of insulation on all four sides and the corners.

With the composition disclosed in the present invention, the magnet wire aims at solving these technical problems.

### BRIEF DISCLOSURE OF THE INVENTION

The invention is set out in the appended set of claims. An object of the invention is thus a wire as defined in claims 1-45.

Another object of the invention is a method for making a wire as defined in any one of claims 46-48.

Another object of the invention is an electric machine or a stator as defined in claims 49 and 50.

Another object of the invention is the use as defined in claim 51.

Another object is an electric machine comprising at least one wire of the invention.

More precisions and details about these objects are now provided below.

### DISCLOSURE OF THE INVENTION

The wire of the invention comprises:
a conductor; and
at least one insulation layer formed around the conductor and in direct contact with the conductor, wherein the insulation layer comprises or is made of a composition comprising at least one polyaryletherketone polymer and 6 to 40 wt. % of talc, with respect to the total weight of the composition, and wherein the composition has a melt viscosity of at least 120 Pa·s when measured according to ASTM D3835 at 400° C. and 1000 s⁻¹.

Thus, the insulation layer used in the context of the present invention may comprise the composition comprising polyaryletherketone polymer and talc disclosed in the invention. The insulation layer used may also be made of the composition comprising polyaryletherketone polymer and talc disclosed in the invention.

The use of the composition as above defined has been found to eliminate the need for adhesive agents, enamel or promoters between the conductor and the thermoplastic insulation layer.

The insulation layer may be formed directly around a conductor. In some embodiments, one or more insulation layers may be formed around a conductor.

In other embodiments, the conductor may comprise a surface treatment, with the proviso that said surface treatment does not comprise any adhesive thermoplastic or thermosetting polymer. The surface treatment is more particularly selected from flame treatment, mechanical abrasion (e.g. shot blasting) and chemical treatment (e.g. etching). The surface is treated to alter its surface prior to the application of the insulation layer. The surface is treated to chemically modify the surface and/or to alter the surface profile.

The at least one insulation layer may be formed by extruding the composition around the conductor. In certain embodiments, the composition may be extruded directly around the conductor.

In some embodiments, the wire is a magnet wire.

### Composition

Details and embodiments relating to the composition polyaryletherketone polymer/talc are now provided. The proportions of the ingredients of the composition are given in wt. % and based on the total weight of the composition.

The composition comprises at least one polyaryletherketone polymer and from 6.0 to 40.0 wt. % of talc, with respect to the total weight of the composition. The composition comprises from 6 to 40 wt. % of talc, based on the total weight of the composition.

As is specified below in more details, the composition comprises or consists of:
at least one PAEK polymer;
from 6.0 to 40.0 wt. % of talc;
optionally at least one PAES polymer;
optionally at least one nucleating agent;
optionally at least one plastic additive.

### 1^{st} Embodiment

According to this 1^{st} embodiment, the proportion of talc is at least 10.0 wt. %. The composition preferably comprises at least 11 wt. % and/or at most 30 wt. %, preferably at most 28 wt. % of talc, with respect to the total weight of the composition.

The proportion of talc is advantageously at least 11.0 wt. %, even at least 11.5 wt. %, even at least 12.0 wt. %, even at least 12.5 wt. %, even at least 13.0 wt. %, even at least 13.5 wt. %, even at least 14.0 wt. %, even at least 14.5 wt. %, even at least 15.0 wt. %.

The proportion of talc is advantageously at most 30.0 wt. %, even at most 29.5 wt. %, even at most 29.0 wt. %, even at most 28.5 wt %, even at most 28.0 wt. %, even at most 27.5 wt. %, even at most 27.0 wt. %, even at most 26.5 wt. %, even at most 26.0 wt. %, even at most 25.5 wt. %, even at most 25.0 wt. %.

Compositions comprising from 10.0 to 26.0 wt. % of talc have been found to provide good adhesion to the conductor.

### 2^{nd} Embodiment

According to this 2^{nd} embodiment, the proportion of talc is between 5.0 and 10.0 wt. %.

The proportion of talc is advantageously at least 5.5 wt. %, even at least 6.0 wt. %, even at least 6.5 wt. %.

The proportion of talc is advantageously at most 9.5 wt. %, even at most 9.0 wt. %, even at most 8.5 wt. %, even at most 8.0 wt. %, even at most 7.5 wt. %, even at most 7.0 wt. %.

A composition comprising between 5.5 and 9.5 wt. %, even between 6.0 and 9.0 wt %, even between 6.3 an 8.5 wt. % of talc, has been found to exhibit a good compromise of properties, in particular a good adhesion on the conductor and a good elongation at break.

The composition of the insulation layer may comprise or be made of only one PAEK polymer.

The composition of the insulation layer may also comprise or be made of more than one PAEK polymer. The PAEK polymers in the composition may differ in terms of the nature and ratio of the recurring units (RPAEK) in the polymer or they may differ in terms of molecular weight, i.e. melt viscosity.

The composition may also comprise or be made of one PAEK polymer and a polymer of a different nature.

More details about the ingredients of the composition are now provided.

### Paek Polymer

The composition comprises or is made of at least one polyaryletherketone polymer, hereinafter referred to as “PAEK polymer”. As used herein, the expression “PAEK polymer” refers to any polymer including at least 50 wt. % of recurring units (RPAEK) having a Ar—C(═O)—Ar′ group, with Ar and Ar′, equal to or different from each other, being aromatic groups.

In some embodiments the PAEK polymer, has at least 60 wt. %, at least 80 wt. %, at least 90 wt. %, at least 95 wt. % or at least 98 wt. % recurring units (RPAEK). The recurring units (R_{PAEK}) can be represented by a formula selected from the group consisting of formulae (J-A) to (J-Q), herein below:

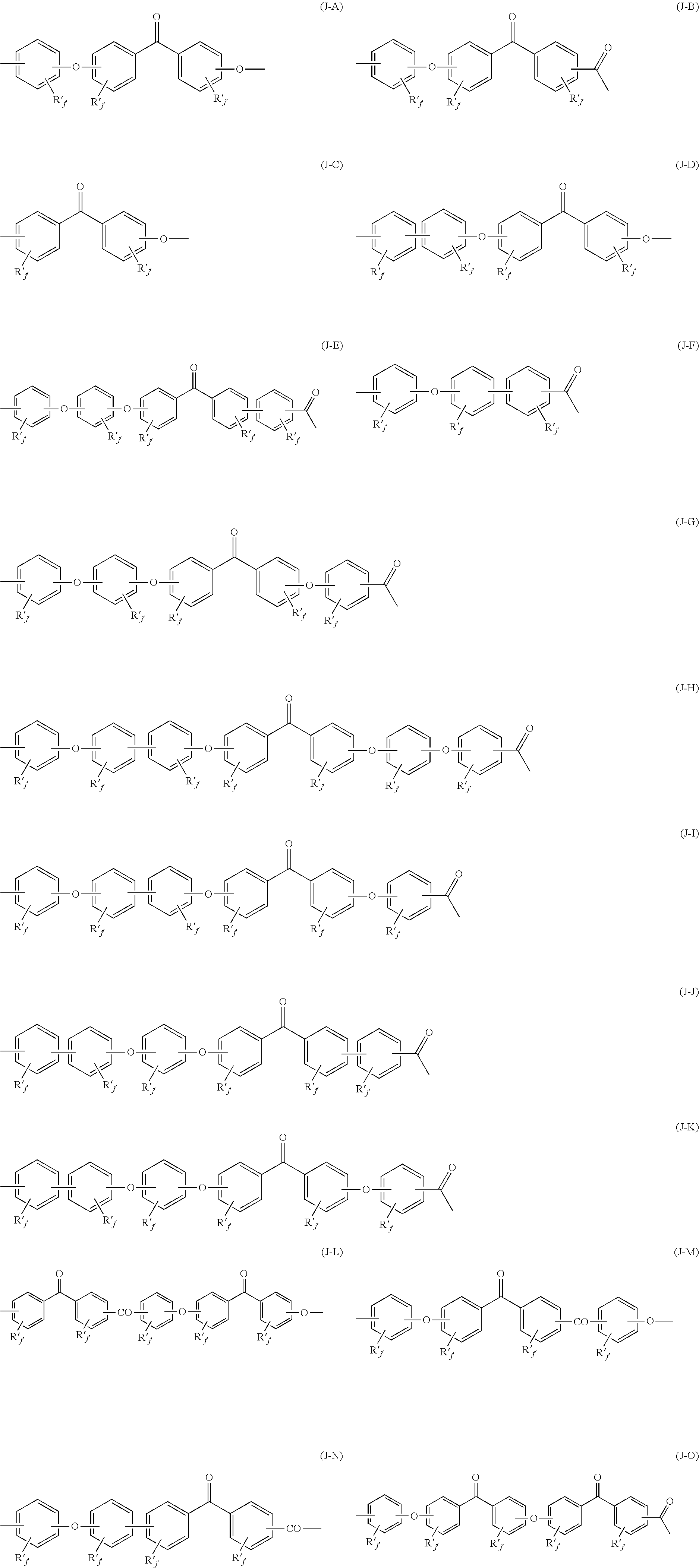

where:
   each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
   j′ is zero or is an integer from 0 to 4. j′ is preferably 0.

In some embodiments, the respective phenylene moieties of recurring unit (R_{PAEK}) can independently have 1,2-, 1,4- or 1,3-linkages to the other moieties different from R′ in the recurring unit. In some embodiments, the phenylene moieties have 1,3- or 1,4-linkages. In further embodiments, the phenylene moieties have 1,4-linkages.

Furthermore, in some embodiments, j′ in recurring units (R_{PAEK}) can be at each occurrence zero; that is to say that the phenylene moieties have no other substituents than those enabling linkage in the main chain of the polymer. In some such embodiments, recurring units (R_{PAEK}) can be represented by a formula selected from the group of formulae (J′-A) to (J′-O) below:

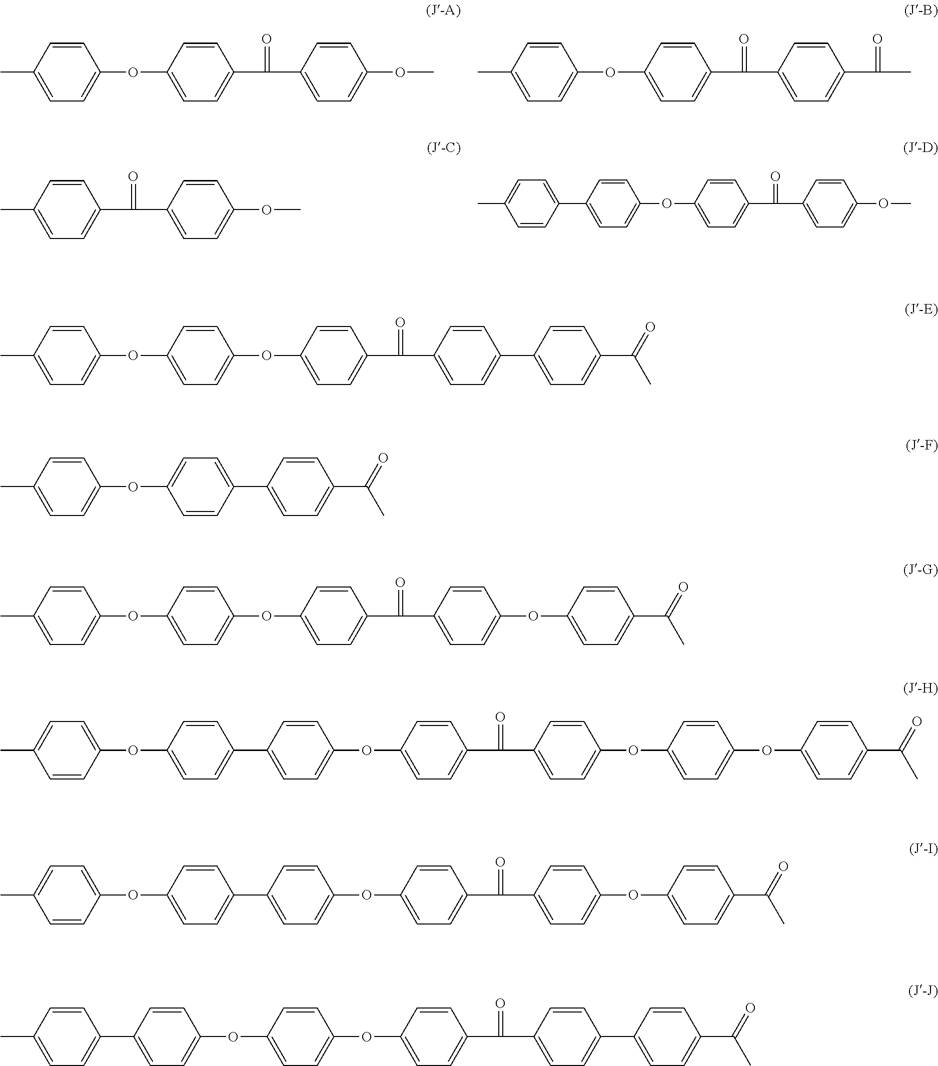

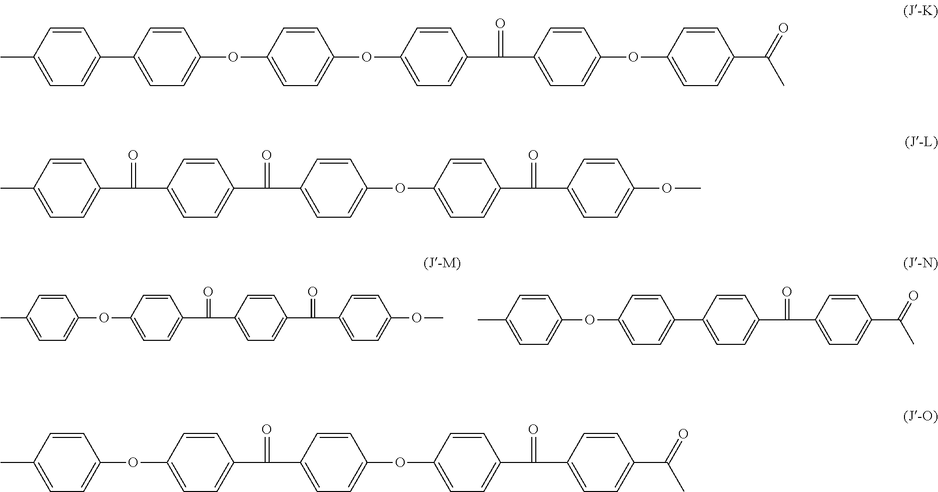

The PAEK polymer may be a homopolymer, a random, alternate or block copolymer. When the PAEK polymer is a copolymer, it may contain (i) recurring units (R_{PAEK}) of at least two different formulae chosen from formulae (J-A) to (J-O), or (ii) recurring units (R_{PAEK}) of one or more formulae (J-A) to (J-O) and recurring units (R*_{PAEK}) different from recurring units (R_{PAEK}).

According to some embodiments, the recurring units (R_{PAEK}) are selected from the group consisting of units of formulae (J′-A) to (J′-D):

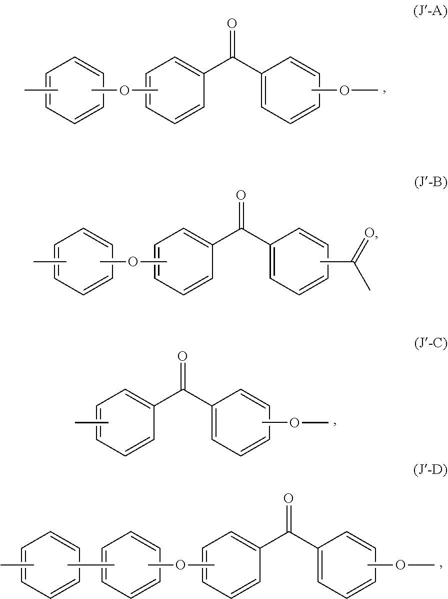

The PAEK is prepared by polycondensation techniques well known in the art, notably a nucleophilic route or an electrophilic one. More precisely, the PAEK may be prepared by a nucleophilic aromatic substitution in which a diaryl ether linkage is obtained. The polycondensation is generally conducted in a solvent, such as a diphenyl sulfone, at 300° C. or more with the aid of a base such as K₂CO₃. More specifically also, the PAEK may be obtained by polycondensation of a mixture of at least one aromatic compound bearing two hydroxy groups and at least aromatic compound bearing two halogens, e.g. fluorine. For instance, a PEEK is generally prepared by reacting hydroquinone with 4,4′-difluorobenzophenone in diphenylsulfone in the presence of at least one alkali-metal carbonate under an inert atmosphere at high temperatures, e.g. >300° C. Details about the polycondensation involving the nucleophilic substitution may be found in e.g. U.S. Pat. No. 4,176,222.

More precisely, the PAEKs may be prepared by a Friedel-Crafts electrophilic substitution in which a diaryl ketone linkage is obtained. The polycondensation is generally conducted in a solvent at temperatures below 150° C. with the aid of a Lewis acid such as AlCl₃. Details about the polycondensation involving the Friedel-Crafts electrophilic substitution may be found in e.g. U.S. Pat. Nos. 4,841,013, 4,816,556, WO 2011/004164 and WO 2014/013202.

### PEEK

The PAEK polymer in the composition may more particularly be a polyetheretherketone (“PEEK”) polymer. As used herein, the term “PEEK polymer” refers to any polymer in which at least 50 wt. % of the recurring units are recurring units (R_{PAEK}) of formula J′-A. In some embodiments, at least 75 wt. %, at least 85 wt. %, at least 95 wt. %, or at least 99 wt. % of the recurring units of the PEEK polymer are recurring units of formula J′-A. In some embodiments, 99.99 wt. % of the PEEK polymer are recurring units of formula J′-A. In some embodiments, substantially all of the recurring units of the PEEK polymer are recurring units of formula J′-A.

The PAEK polymer can be prepared by any method known in the art for the manufacture of polyaryletherketone polymers. See above. Furthermore, PEEK is commercially available as KetaSpire® polyetheretherketone from Solvay Specialty Polymers USA, LLC.

As mentioned above, the composition may comprise or be made of more than one PAEK polymer. For instance, the PAEK polymer may correspond to a combination of two PEEKs (PEEK1 and PEEK2) that differ by their melt viscosities as measured using a capillary rheometer with a die having dimensions of 0.5 mm diameter×3.175 mm length according to ASTM D3835 at 400° C. at a shear rate of 1,000 s⁻¹.

In some embodiments, at least 75 wt. %, at least 85 wt. %, at least 95 wt. %, or at least 99 wt. % of the recurring units of PEEK1 and PEEK2 are recurring units of formula J′-A. In some embodiments, 99.99 wt. % of PEEK1 and PEEK2 are recurring units of formula J′-A. In some embodiments, substantially all the recurring units of PEEK1 and PEEK2 are of formula J′-A.

PEEK1 may more particularly exhibit a viscosity (in the conditions above) higher than 300 Pa s. The viscosity of PEEK1 may be between 350 and 600 Pa s. An example of suitable PEEK1 is KetaSpire® KT-820 high viscosity grade PEEK with a melt viscosity 380-500 Pa·s.

PEEK2 may more particularly exhibit a viscosity (in the conditions above) lower than 200 Pa s. The viscosity of PEEK2 may be between 100 and 200 Pa s. An example of suitable PEEK2 is KetaSpire® KT-880 high viscosity grade PEEK with a melt viscosity 120-180 Pa·s.

The weight ratio PEEK1/PEEK2 may be between 50/50 and 70/30, even between 60/40 and 70/30.

### Composition PAEK/PAES

In an alternative embodiment, the composition may comprise one PAEK polymer and a polymer of a different nature. In an advantageous aspect of this embodiment, the composition may comprise at least one PAEK polymer and at least one polyarylethersulfone polymer, hereinafter “PAES polymer”. The expression “PAES polymer” denotes any polymer of which at least 50 mol % of the recurring units are recurring units (R_{PAES}) of formula:

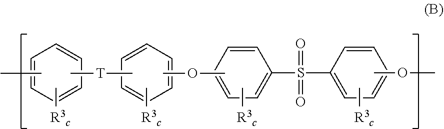

where:
   each R³, equal to or different from each other, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
   each c, equal to or different from each other, is independently selected from 0, 1, 2, 3, and 4, preferably 0; and
   T is selected from the group consisting of a bond, a sulfone group [—S(═O)₂—], and a group-C(R⁴) (R⁵)—, where R⁴ and R⁵, equal to or different from each other, is independently selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium. R⁴ and R⁵ are preferably methyl groups.

Preferably at least 60 mol %, 70 mol %, 80 mol %, 90 mol %, 95 mol %, 99 mol % of recurring units (R_{PAES}) are recurring units of formula (B).

The PAES polymer is prepared by polycondensation techniques well known in the art, notably a nucleophilic route involving an optionally substituted 4,4′-dihalodiphenyl sulfone, notably optionally substituted 4,4′-dichlorodiphenyl sulfone.

In some embodiments, the PAES is a polyphenylsulfone (PPSU). As used herein, a “polyphenylsulfone (PPSU)” denotes any polymer of which more than 50 mol % of the recurring units (R_{PAES}) are recurring units of formula:

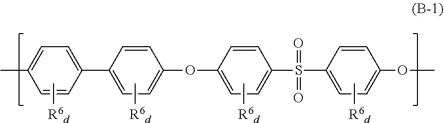

where each R⁶ and d, at each instance, is independently selected from the groups described above for R³ and c, respectively. Preferably each d in formula (B-1) is zero.

Preferably at least 60 mol %, 70 mol %, 80 mol %, 90 mol %, 95 mol %, 99 mol % of recurring units (R_{PAES}) are recurring units of formula (B-1).

PPSU can be prepared by known methods and is available as RADEL® PPSU from Solvay Specialty Polymers USA, L.L.C.

The PPSU suitable for use in this invention can have melt flow rates (MFR) as measured according to ASTM D1238 using a temperature of 365° C. and a 5.0 kg weight ranging from 5.0 to 45.0 g/10 min, preferably from 10.0 to 40.0 g/10 min, more preferably from 15.0 to 35.0 g/10 min and even more preferably from 20.0 to 30.0 g/10 min.

In some embodiments, the PAES is a polyethersulfone (PES). As used herein, a “polyethersulfone (PES)” denotes any polymer of which more than 50 mol % of the recurring units (R_{PAES}) are recurring units of formula:

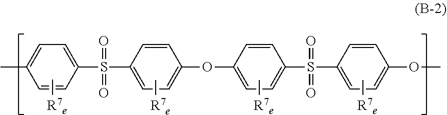

where each R⁷ and e, at each instance, is independently selected from the groups described above for R³ and c, respectively. Preferably each e in formulae (B-2) is zero.

Preferably at least 60 mol %, 70 mol %, 80 mol %, 90 mol %, 95 mol %, 99 mol % of recurring units (R_{PAES}) are recurring units of formula (B-2).

PES can be prepared by known methods and is available as VERADEL® PESU from Solvay Specialty Polymers USA, L.L.C.

The PES suitable for use in this invention can have melt flow rates (MFR) as measured according to ASTM D1238 using a temperature of 380° C. and a 2.16 kg weight ranging from 10.0 to 50.0 g/10 min, preferably from 15.0 to 45.0 g/10 min, more preferably from 20.0 to 40.0 g/10 min and even more preferably from 25.0 to 35.0 g/10 min.

In some embodiments, the PAES is a polysulfone (PSU). As used herein, a “polysulfone (PSU)” denotes any polymer of which more than 50 mol % of the recurring units (R_{PAES}) are recurring units of formula:

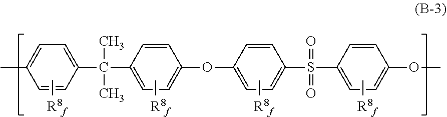

where each R⁸ and f, at each instance, is independently selected from the groups described above for R³ and c, respectively. Preferably each f in formulae (B-3) is zero.

Preferably at least 60 mol %, 70 mol %, 80 mol %, 90 mol %, 95 mol %, 99 mol % of recurring units (R_{PAES}) are recurring units of formula (B-3).

PSU can be prepared by known methods and is available as UDEL® PSU from Solvay Specialty Polymers USA, L.L.C.

Preferably the PAES is selected from the group consisting of PSU, PPSU, and a combination thereof. In some embodiments, the PAES includes PSU and PPSU. Most preferably, the PAES is PPSU.

The PSU suitable for use in this invention can have melt flow rates (MFR) as measured according to ASTM D1238 using a temperature of 343° C. and a 2.16 kg weight ranging from 2.0 to 20.0 g/10 min, preferably from 3.0 to 16.0 g/10 min, more preferably from 4.0 to 12.0 g/10 min and even more preferably from 5.0 to 9.0 g/10 min.

In the context of the invention, the composition may more particularly comprise or consist of:
at least one PAEK polymer;
from 6.0 to 40.0 wt. % of talc;
optionally at least one PAES polymer selected from the group of PPSU, PSU, PES and combinations thereof;
optionally at least one nucleating agent;
optionally at least one plastic additive.

The PAES polymer may more particularly be selected from the group of PPSU, PSU and combinations thereof.

When present, the amount of PAES in the polymer composition preferably ranges from 1.0 to 45.0 wt. %, preferably from 30.0 to 40.0 wt. %, based on the total weight of the PAEK and the PAES polymers in the composition.

In the context of the invention, the composition may more particularly comprise or consist of:
at least one PAEK polymer;
from 6.0 to 40.0 wt. % of talc;
optionally at least one PPSU;
optionally at least one nucleating agent;
optionally at least one plastic additive.

When present, the amount of PPSU(s) in the polymer composition preferably ranges from 1.0 to 45.0 wt. %, preferably from 30.0 to 40.0 wt. %, based on the total weight of the PAEK and the PPSU polymers in the composition.

In the context of the invention, the composition may more particularly comprise or consist of:
at least one PAEK polymer;
from 6.0 to 40.0 wt. % of talc;
optionally at least one PSU;
optionally at least one nucleating agent;
optionally at least one plastic additive.

When present, the amount of PSU(s) in the polymer composition preferably ranges from 1.0 to 45.0 wt. %, preferably from 30.0 to 40.0 wt. %, based on the total weight of the PAEK and the PSU polymers in the composition.

The composition may advantageously comprise 55.0 to 70.0 wt % PEEK and 45.0 to 30.0 wt % PPSU based on the total weight of PEEK and PPSU in the composition.

The composition comprising PAEK and PAES may also be based on the combination of two PEEKs as disclosed above. In other words for this embodiment, the PAEK polymer may correspond to a combination of two PEEKs (PEEK1 and PEEK2) differing by their melt viscosities as measured using a capillary rheometer with a die having dimensions of 0.5 mm diameter×3.175 mm length according to ASTM D3835 at 400° C. at a shear rate of 1,000 s⁻¹. All details and embodiments relating to this combination PEEK1/PEEK2 applies here too.

### Talc

The term “talc” refers to either magnesium silicate mineral or the mineral chlorite (magnesium aluminium silicate), or a mixture of the two, optionally associated with other minerals, for example, dolomite and/or magnesite. The term “talc” may also refer to a synthetic talc, also known as talcose.

Talc is advantageously a natural hydrated magnesium silicate.

The particles of talc may have any suitable dimensions and/or aspect ratios.

Talc advantageously exhibits a D50 lower than 10.0 μm, even lower than 7.0 μm, even lower than 5.0 μm. D50 is advantageously higher than 0.5 μm, even higher than 1.0 μm. D50 may be between 0.5 and 10.0 μm, preferably between 7.0 μm, preferably between 0.5 and 5.0 μm, preferably between 1.0 and 5.0 μm.

Talc advantageously exhibits a D10 higher than 0.1 μm, even higher than 0.2 μm. D10 may be between 0.1 and 1.0 μm or between 0.2 and 1.0 μm.

Talc advantageously exhibits a D90 lower than 15.0 μm, even lower than 10.0 μm. D90 may be between 5.0 and 15.0 μm or between 0.2 and 1.0 μm.

D10, D50 and D90 are determined from a distribution (in volume) of the equivalent spherical diameters of the particles which is obtained by a sedimentation method. One can use the “Sedigraph III 5120” machine as supplied by Micromeritics Instruments Corporation, Morcross, Georgia, USA (more details at www.micromeritics.com:

http://www.micromeritics.com/Repository/Files/SediGraph_5120_Brochure.pdf). This technique and the sedigraph make it possible to determine the distribution by measuring the rate at which particles fall under gravity. The technique and the sedigraph use a narrow collimated beam of X-rays to measure directly the particle concentration in the liquid medium.

D10, D50 and D90 have the usual meaning used statistics and in the field of particle size analysis. See for instance https://www.horiba.com/fileadmin/uploads/Scientific/Documents/PSA/PSA

Guidebook.pdf. D50 (median) is defined as the size value corresponding to the cumulative distribution at 50%. Similarly, D10 and D90 are defined as the size corresponding to the cumulative distribution at respectively 10% and 90%.

Suitably the talc may exhibit the following properties:
a D50 between 1.0 and 5.0 μm; and
a D10 higher than 0.1 μm and/or a D90 lower than 15.0 μm.

### Nucleating Agent

In some embodiments, the composition can optionally include also at least one nucleating agent. The proportion of the nucleating agent(s) is generally less than 2.0 wt. %, even less than 1.5 wt. %. The nucleating agent is selected from the group consisting of boron nitride, graphite, graphene, mica and combinations thereof. Graphene is also known as graphitic nanoplatelets. The nucleating agent is preferably boron nitride.

The nucleating agent helps speed up the crystallization of the molten composition once it has been extruded on the conductor, notably for the composition based on PAEK and PAES This ensures better overall performance of the coating on the wire—for example chemical resistance—by virtue of the higher level of crystallinity in the coating. Moreover, the nucleating agent helps increase the throughput of the preparation of the wire coating.

### Plastic Additive(s)

In some embodiments, the composition can optionally include one or more additives including, but not limited to, a colorant (e.g., a dye and/or a pigment), ultraviolet light stabilizers, heat stabilizers, antioxidants, an acid scavenger, processing aids, an internal lubricant and/or an external lubricant, flame retardants, a smoke-suppressing agent, an anti-static agent, an anti-blocking agent, or any combination thereof.

When one or more other additives are present, the composition can include no more than 50 wt. %, no more than 20 wt. %, no more than 10 wt. % or no more than 5 wt. % of one or more other additives, relative to the total weight of the composition. Most preferably, the proportion of the plastic additive(s) is less than 5.0 wt. %.

### Viscosity of the Composition

The composition has a melt viscosity measured according to ASTM D3835 at 400° C. and 1000 s⁻¹, using a tungsten carbide die of 0.5×3.175 mm, of at least 120 Pa·s, even at least 130 Pa·s, still at least 150 Pa·s, even at least 200 Pa·s, preferably at least 250 Pa·s, more preferably at least 270 Pa·s. This viscosity may also be at least 300 Pa·s, more preferably at least 320 Pa·s.

The composition may advantageously have a melt viscosity, measured according to ASTM D3835 at 400° C. and 1000 s⁻¹, using a tungsten carbide die of 0.5×3.175 mm, of at most 600 Pa·s, even at most 580 Pa·s, preferably at most 550 Pa·s, more preferably at most 520 Pa·s, most preferably at most 500 Pa·s.

Compositions having melt viscosities in the range of 250 to 520 Pa·s, preferably between 250 and 500 Pa·s, preferably between 300 and 500 Pa·s, or between 300 and 400 Pa sor even preferably between 300 and 360 Pa s have been found to provide surprisingly good adhesion to the conductor.

Viscosity at 10000 s⁻¹: the composition may have a melt viscosity measured according to ASTM D3835 at 400° C. and 10000 s⁻¹, using a tungsten carbide die of 0.5×3.175 mm, of at least 50 Pa s, evan at least 90 Pa·s, even at least 100 Pa·s. The composition may have a melt viscosity measured according to ASTM D3835 at 400° C. and 10000 s⁻¹, using a tungsten carbide die of 0.5×3.175 mm, of at most 130 Pa·s, even at most 120 Pa·s.

Viscosity at 100 s⁻¹: the composition may have a melt viscosity measured according to ASTM D3835 at 400° C. and 100 s⁻¹, using a tungsten carbide die of 0.5×3.175 mm, of at least 200 Pa·s, even at least 400 Pa·s. The composition may have a melt viscosity measured according to ASTM D3835 at 400° C. and 100 s⁻¹, using a tungsten carbide die of 0.5×3.175 mm, of at most 1000 Pa·s, even at most 900 Pa·s.

Ratio r of viscosities: it has also been discovered that a good balance of properties is obtained when the ratio r of viscosities is between 5.0 and 10.0, r being defined as the ratio of the melt viscosity at 400° C. and 100 s⁻¹ divided by the melt viscosity 400° C. and 10000 s⁻¹. Ratio r is preferably at least 6.0. Ratio r is preferably at most 9.0 or at most 8.0.

Ratio r may also preferably be between 5.0 and 9.0, preferably between 6.0 and 8.0.

### Tensile Elongation at Break

The composition advantageously exhibits tensile elongation at break, as measured according to ASTM D638 (Type I specimen with 3.2 mm thickness, 50 mm/min) of at least 10.0%, preferably at least 13.0%, more preferably at least 16.0%, and even more preferably at least 20.0%.

The tensile elongation at break is usually at most 30.0%, even at most 15.0%.

### Method of Preparation of the Composition

The composition can be manufactured by any known melt-mixing process that is suitable for preparing thermoplastic compositions or compounds. This process is conveniently carried out in a melt-mixing apparatus. Any melt-mixing apparatus known to the one skilled in the art of preparing polymer compositions by melt mixing can be used.

A suitable melt-mixing apparatus may for example be selected in the list consisting of kneaders, Banbury mixers, single-screw extruders and twin-screw extruders. A convenient melt-mixing apparatus is a single-screw extruder or a twin-screw extruder. A convenient melt-mixing apparatus can be the one used in the examples.

The design of the compounding screw (e.g. flight pitch and width, clearance, length) as well as the operating conditions of the extruder are preferably and advantageously chosen so that sufficient heat and mechanical energy is provided to fully melt the polymer ingredients of the composition and obtain a homogeneous distribution of the various ingredients of the composition. At the outlet of the extruder, strand extrudates of the composition can be chopped by means e.g. of a rotating cutting knife after some cooling time on a conveyer with water spray. The composition may be in the form of a powder or in the form of pellets. The latter form is preferred as being more convenient to use.

The preparation method in the examples may advantageously be followed for the preparation of the composition of the invention.

### Insulation Layer

In some embodiments, the insulation layer consists of the composition as above detailed.

The thickness of the insulation layer is typically less than 200 μm, even less than 180 μm. The thickness of the insulation layer is preferably 5 μm or more, and more preferably 15 μm.

The composition disclosed in the present invention makes it possible to increase the thickness while keeping a good compromise of properties. The thickness may be increased up to 300.0 μm. The thickness of the insulation layer may thus generally be between 5.0 and 300.0 μm.

The composition provides a good insulation of the conductor. As the composition is crystalline, it provides also a good chemical and mechanical resistance.

### Electrical Conductor

The conductor may be formed from a wide variety of suitable materials and/or combinations of materials. For example, the conductor may be formed from copper, aluminum, annealed copper, oxygen-free copper, silver-plated copper, nickel plated copper, copper clad aluminum, silver, gold, a conductive alloy, a bimetal, carbon nanotubes, or any other suitable electrically conductive material. Typically, the conductor is a copper-based conductor. Typically, the conductor consists essentially of copper.

Additionally, the conductor may be formed with any suitable dimensions and/or cross-sectional shapes. The conductor may have a circular or round cross-sectional shape or it may be formed with a square shape, a rectangular shape, an elliptical or oval shape, or any other suitable cross-sectional shape.

The conductor may have any suitable dimensions, such as any suitable gauge, diameter, height, width, cross-sectional area, etc.

The wire may comprise more than one insulation layers and/or additional layers with the proviso that at least one insulation layer, as above defined, is in direct contact with the surface of the conductor. It has been found that the composition of the inventive insulation layer allow to obtain good adhesion of the insulation layer to the conductor in the absence of any adhesive layer and/or enamel. The inventive wire is thus free of any adhesive and/or enamel layer between the conductor and the composition.

When more than one insulation layers are used they may have the same or different compositions.

In certain embodiments, in addition to the one or more insulation layers the wire may include one or more suitable wraps or tapes. For instance a polymeric tape may be wrapped around the conductor and the insulation layer(s). In other embodiments, the wire may include one or more layers of extruded material having a composition different from the composition of the insulation layer.

### Method for Making the Wire

A further object of the invention is a method for making the wire.

In certain embodiments, the conductor may be formed in tandem with the application of the insulation layer. In other embodiments, a conductor with desired dimensions may be preformed or obtained from an external source. The insulation layer may then be applied or otherwise formed on the conductor.

In certain embodiments, the insulation layer is extruded and the extruded insulation is formed directly around the conductor. The insulation layer may be formed directly around the conductor using known extrusion coating techniques. The extruded insulation layer may be formed with any suitable thickness as desired. The extruded insulation layer thickness is selected in such a way to be thin enough to allow a relatively tight packing of the resulting wire, for example in an electric motor, but thick enough to provide suitable insulation and/or mechanical resistance. The conditions used in the examples can apply and be used for copper but also for any other metal.

In an alternative embodiment, the insulation layer may be extruded in the form of a film or tape and then applied to the conductor. For instance, the insulation layer may be wound around the conductor and then subjected to a heat treatment to consolidate the structure.

In other embodiments, one or more suitable surface modification treatments may be utilized on a conductor to promote adhesion with the insulation layer. For example, the surface of the conductor may be roughened. Roughening can include etching (e.g. chemical etching or laser etching), mechanical grinding, or any combination therefore. Examples of alternative and/or additional surface modification treatments include, but are not limited to, a plasma treatment, an ultraviolet (“UV”) treatment, a corona discharge treatment, and/or a gas flame treatment. A surface treatment may alter the topography of a conductor and/or form functional groups on the surface of the conductor that enhance or promote bonding of a subsequently formed insulation layer. As a result, surface treatments may reduce interlayer delamination.

### Wire

The wire of the invention may be used in a wide variety of applications, including a wide variety of electric machines and devices, such as inverter drive motors, motor starter generators, transformers and the like.

The electrical machine may also be an electric motor, an alternator or a generator. This electrical machine comprises a stator and a rotor. The stator comprises a metallic core with the wire of the invention. The invention extends to a stator incorporating the wire of the invention.

The wire may have a circular cross-section.

The wire may also have a non-circular cross-section. For instance, the wire may have a square shape cross-section, a rectangular shap cross-section, an elliptical cross-section or oval shape cross-section. The wire may also have a cross-section which is substantially square, substantially rectangular, substantially elliptical or substantially oval.

More particularly, the wire may exhibit a cross-section which includes a first outwardly facing surface and a second outwardly facing surface, wherein said first and second surfaces are preferably substantially planar and, preferably, said first and second surfaces face in opposite directions but extend substantially parallel to one another.

Should the disclosure of any patents, patent applications, and publications which are incorporated herein by reference conflict with the description of the present application to the extent that it may render a term unclear, the present description shall take precedence.

The present invention is described in greater detail below by referring to the Examples; however, the present invention is not limited to these examples.

### EXAMPLES

Raw materials:

KetaSpire® KT-820 high viscosity grade PEEK with a melt viscosity of 420 Pa·s as measured using a capillary rheometer with a die having dimensions of 0.5 mm diameter×3.175 mm length according to ASTM D3835 at 400° C. at a shear rate of 1,000 s⁻¹.

KetaSpire® KT-880 low viscosity grade PEEK with a melt viscosity of 150 Pa-s as measured using the same above-mentioned conditions.

Radel® R-5800 NT: PPSU available from Solvay Specialty Polymers. This grade exhibits a MFR of 25 g/10 min as measured according to ASTM D1238 using a temperature of 365° C. and 5.0 kg weight.

Talc: Mistron® Vapor from Imerys Perfomance Additives; median particle size D50 of about 2 μm. D10=0.5 μm and D90=7.4 μm. These values are obtained with a Sedigraph.

Hostanox P-EPQ is an antioxidant agent sourced from Clariant Corp.

### Preparation of Example Compositions

All compositions were prepared by first tumble blending powders of the polymers and talc to be blended at the desired compositional ratios for about 20 minutes, followed by melt compounding using a 26 mm Coperion® co-rotating partially intermeshing twin screw extruder having an L/D ratio of 48:1. The extruder had 12 barrel sections with a temperature profile setting of 350° C. for barrel sections 2-12 and the pin-hole die. The melt temperature recorded for the extrudate as it exited the die ranged between 370 and 390° C. for all the compositions. The feeding of the extruder was such that the resin component(s) were metered gravimetrically at the extruder feed hopper, while the desired filler was metered also using a gravimetric feeder at the proportion corresponding to Table 1 at barrel section 7. The extruder was operated at a total throughput rate of 35 lb/hr (15.9 kg/hr) and 200 rpm screw speed, and the extruder torque reading was maintained around 75% during compounding of all the compositions. Vacuum venting with a vacuum level >25 in Hg was applied at barrel section 10 during compounding to strip off moisture and any possible residual volatiles from the compound. The extrudate from each of the runs was stranded and cooled in a water trough and then pelletized into pellets approximately 2.7 mm in diameter and 3.0 mm in length.

### Preparation of Test Films

The prepared pellets of example compositions were processed into 130-150 μm thickness and 8-9 cm wide films using a single screw extruder from OCS Optical Control Systems, GmbH. The extruder had a single stage non-vented screw with a diameter of 20 mm and an L/D ratio of 30. It was equipped with a film die 125 mm wide having a 0.5 mm gap thickness. The extruder barrel had four heated sections which were operated from rear to front at temperature settings of approximately: 350, 385, 390, and 395° C., respectively. The film die was set at a temperature of 395° C. The film was drawn and formed on two chill rolls, set at 240 and 245° C. for the first and second roll, respectively. The throughput rate of the film and compound were defined by a take-up rate of the film of about 1 m/min and the extruder was operated at a screw speed of 17 rpm.

### Preparation of Wire Samples

Select formulations were extruded onto copper wire for testing. Bare round copper wire of size AWG12 was coated with polymer using an Entwistle 1.5-in (3.8 cm) extruder and Unitek fixed-center crosshead. Wire was cleaned and then preheated to the desired temperature between 30° and 450° C. using a Zumbach induction heater before polymer was extruded onto the wire. Pressure tooling was used with a 0.082-in (0.21 cm) tip and a 0.090-in (0.23 cm) die. The line was run between 12 and 37 m/min and a 0.005-in (0.12 mm) wall thickness was targeted. The wire was cooled in ambient air before being collected for testing.

The thickness of the insulation layer of the wire samples was 125 μm.

### Testing

The following ASTM test methods were employed in evaluating all compositions:
D638: Tensile properties-strength, modulus and elongation at break
D3835: Melt viscosity evaluation via capillary rheometry using a tungsten carbide die of 0.5×3.175 mm, at a temperature of 400° C.

Injection molding was performed on the example formulations to produce 0.125-in thick ASTM tensile and flexural specimens for mechanical property testing. Type I tensile ASTM specimens and 5×0.5×0.125-in flexural specimens were injection molded using PEEK injection molding guidelines provided by the supplier.

### Strip Force Testing

A customized fixture was designed and machined to measure the strip force required to remove the coating from the wire, as shown below. A 3-in (7.6 cm) length of wire was used for testing. A 1.5-in (3.8 cm) section of the wire was stripped of its coating material manually and inserted through a 0.083-in (2.1 mm) diameter hole in a drill bushing. The drill bushing was inserted into the fixture attached to an Instron Model 5565 and the uncoated section of wire was clamped in the upper grip. The wire was pulled at a rate of 0.1 in/min (2.5 mm/min), the load on the grip was measured, and the maximum observed load was recorded as the strip force for the sample. The results are summarized in Table 1.

### Peel Strength Testing

Peel testing was performed using the extruded films of each composition to determine the composition's adhesion to metal substrates. For each specimen, a 5×10 cm metal sheet of 0.024-in (0.61 mm) thickness, composed of either copper or stainless steel, was used as the substrate. The metal sheet was cleaned with acetone before the test to remove any residual grease or oil from the surface. The polymer film to be tested was cut to a 3×1.5-in rectangle with the long edge perpendicular to the extruded direction. Aluminum foil was folded over approximately 0.5-in (12.7 mm) of the polymer film at one of the short ends. The upper and lower platens of a melt press were preheated to 400° C. For each test, the polymer film was placed on the metal substrate, the gap between the platens was opened to approximately 5 cm, and the metal/polymer assembly was placed directly on the lower platen next to a preheated 3/16-in (0.5 cm) thick stainless steel plate. The platens were then closed so that the gap between top and bottom platen was 3/16-in (0.5 cm), and the assembly remained in place for 2 minutes. The platens were then opened to a gap of 10 cm with the assembly left on the lower platen for 1 minute. After a total of 3 minutes on the press, the assembly was moved to the 3/16-in (0.5 cm) thick stainless steel hot plate and the plate was moved to the cooling press at ambient temperature.

The 90° peel test was performed on an Instron Model 5565 with jaw faces grip on the upper attachment and sliding platform on the lower attachment. The film adhered to the metal sheet was scored along each long edge before the peel test to remove edge effects, leaving a film section having a width of at least 0.5-in (12.7 mm) to be peeled from the metal substrate. The film was peeled from the substrate at a rate of 0.1 in/min (2.5 mm/min), and the load was recorded and normalized for the scored sample width.

The results are summarized in Table 1, wherein symbols have the following meaning:
(−−−): Delaminated before scoring
(−−+): Partially delaminated before scoring
(−++): Delaminated upon scoring
(+++): Ripped
and wherein the melt viscosities are given in Pa·s.

TABLE 1

| Example | C1 | CE1 | E1 | E2 | E3 | E4 | E5 | E6 | E7 | E8 | E9 | E10 |
|---|---|---|---|---|---|---|---|---|---|---|---|---|
| KetaSpire ® KT-820P PEEK (%) | 100.0 | 97.3 | 93.4 | 87.1 | 80.7 | 74.4 | 56.07 | 0 | 59.9 | 59.6 | 38.9 | 39.0 |
| KetaSpire ® KT-880P PEEK (%) | 0 | 0 | 0 | 0 | 0 | 0 | 30.93 | 87 | 32.2 | 32.9 | 20.9 | 21.0 |
| Radel ® R-5800 NT PPSU (%) | 0 | 0 | 0 | 0 | 0 | 0 | 0 | 0 | 0 | 0 | 32.2 | 32.3 |
| Talc (%) | 0 | 2.5 | 6.4 | 12.7 | 19.1 | 25.4 | 12.8 | 12.8 | 7.9 | 6.4 | 7.9 | 6.4 |
| Boron Nitride Boronid S1-SF (%) | 0 | 0 | 0 | 0 | 0 | 0 | 0 | 0 | 0 | 1.2 | 0 | 1.2 |
| Hostanox P-EPQ (w %) | 0 | 0.2 | 0.2 | 0.2 | 0.2 | 0.2 | 0.2 | 0.2 | 0 | 0 | 0 | 0 |
| Zincoxyd Activ (%) | 0 | 0 | 0 | 0 | 0 | 0 | 0 | 0 | 0 | 0 | 0.1 | 0.1 |
| Melt Viscosity, 400° C., 100 s⁻¹ | 1127 | 1325.2 | 1284.9 | 1115.7 | 1029.7 | 1144.4 | 599.6 | 269.1 | 719.0 | 725.8 | 644.4 | 801.8 |
| Melt Viscosity, 400° C., 1,000 s⁻¹ | 464 | 513.9 | 509.5 | 473.8 | 426.2 | 442.6 | 288.8 | 138.3 | 336.7 | 333.0 | 329.3 | 355.0 |
| Melt Viscosity, 400° C., 10,000 | 186 | 138.6 | 144.3 | 145.6 | 127.4 | 127.6 | 101.8 | 53.7 | 104.6 | 104.2 | 104.0 | 105.4 |
| s⁻¹ | | | | | | | | | | | | |
| Ratio r of viscosities (ratio | 6.06 | 9.56 | 8.90 | 7.66 | 8.08 | 8.97 | 5.89 | 5.01 | 6.87 | 6.97 | 6.20 | 7.61 |
| viscosity at 100 s⁻¹ divided by | | | | | | | | | | | | |
| viscosity at 10000 s⁻¹) | | | | | | | | | | | | |
| Tensile Elongation at Break (%) | 25 | 28 | 23 | 25 | 12 | 7 | 38 | 8.2 | 19 | 20 | 100 | 60.5 |
| 50 mm/min (ASTM D638, Type I | | | | | | | | | | | | |
| specimen with 3.2 mm thickness) | | | | | | | | | | | | |
| Peel Strength/Peel Test Result | (−−−) | (−−+) | (−++) | (+++) | (+++) | (+++) | (+++) | (−++) | N/A | N/A | (+++) | (−++) |
| (Smooth Cu, 400° C. platens, | | | | | | | | | | | | |
| 25. mm/min peel rate) | | | | | | | | | | | | |
| Strip Force wire prepared at | 162 | N/A | 482 | 481 | N/A | N/A | 484 | 500 | N/A | 565 | N/A | N/A |
| 400° C. preheat T (N) | | | | | | | | | | | | |

The adhesion to a smooth metal substrate is improved by the addition of talc with respect to a composition that contains only PEEK or low amounts of talc. The adhesion is at good levels even in the absence of an adhesive layer between the metal substrate and the thermoplastic layer.

The peel strength data show that, at the same loadings of talc, adhesion to the wire increases with higher viscosity of the formulation.

As is shown with the results of Table I, the wires of the examples exhibit a strong adhesion. As can be seen also, the wires of examples E7-E10 exhibit a balance of properties.

1. A wire comprising:
a conductor; and
at least one insulation layer formed around the conductor and in direct contact with the conductor, wherein the insulation layer comprises or is made of a composition comprising at least one polyaryletherketone polymer and 6.0 to 40.0 wt. % of talc, with respect to the total weight of the composition, and wherein the composition has a melt viscosity of at least 120 Pa's when measured according to ASTM D3835 at 400° C. and 1000 s⁻¹.

2. The wire of claim 1 wherein the composition comprises:
at least one polyaryletherketone polymer (PAEK polymer) wherein the PAEK polymer corresponds to a combination of two PEEKs (PEEK1 and PEEK2) that differ by their melt viscosity measured using a capillary rheometer with a die having dimensions of 0.5 mm diameter×3.175 mm length according to ASTM D3835 at 400° C. at a shear rate of 1,000 s⁻¹;
from 6.0 to 40.0 wt. % of talc;
optionally at least one polyarylethersulfone polymer (PAES polymer);
optionally at least one nucleating agent;
optionally at least one plastic additive.

3. The wire of claim 1 wherein the composition comprises:
at least one polyaryletherketone polymer (PAEK polymer);
from 6.0 to 40.0 wt. % of talc;
at least one polyarylethersulfone polymer (PAES polymer);
optionally at least one nucleating agent;
optionally at least one plastic additive.

4. (canceled)

5. (canceled)

6. The wire of claim 1 wherein the polyaryletherketone polymer includes at least 50 wt. % of recurring units (R_{PAEK}) selected from the group consisting of formulae (J-A) to (J-O): 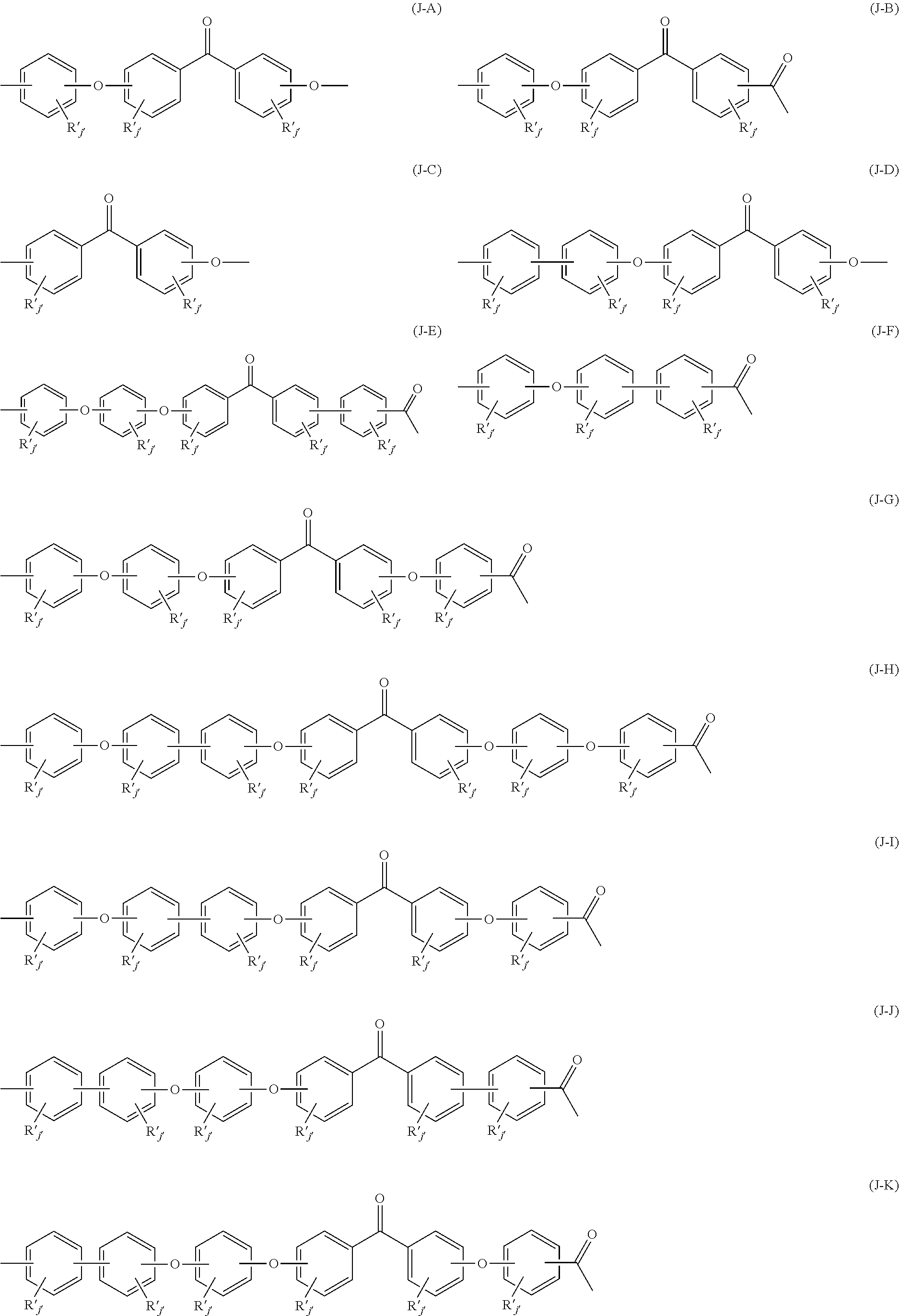 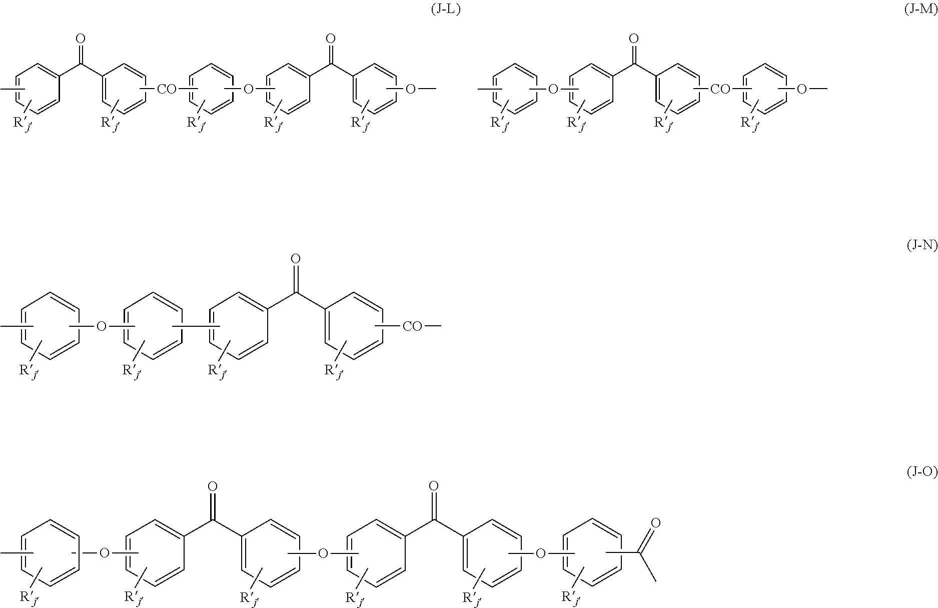
where:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
j′ is zero or is an integer from 0 to 4.

7. (canceled)

8. (canceled)

9. The wire of claim 1 wherein the polyaryletherketone polymer includes at least 50 wt. % of recurring units (R_{PAEK}) selected from the group consisting of formulae (J′-A) to (J′-O) below:

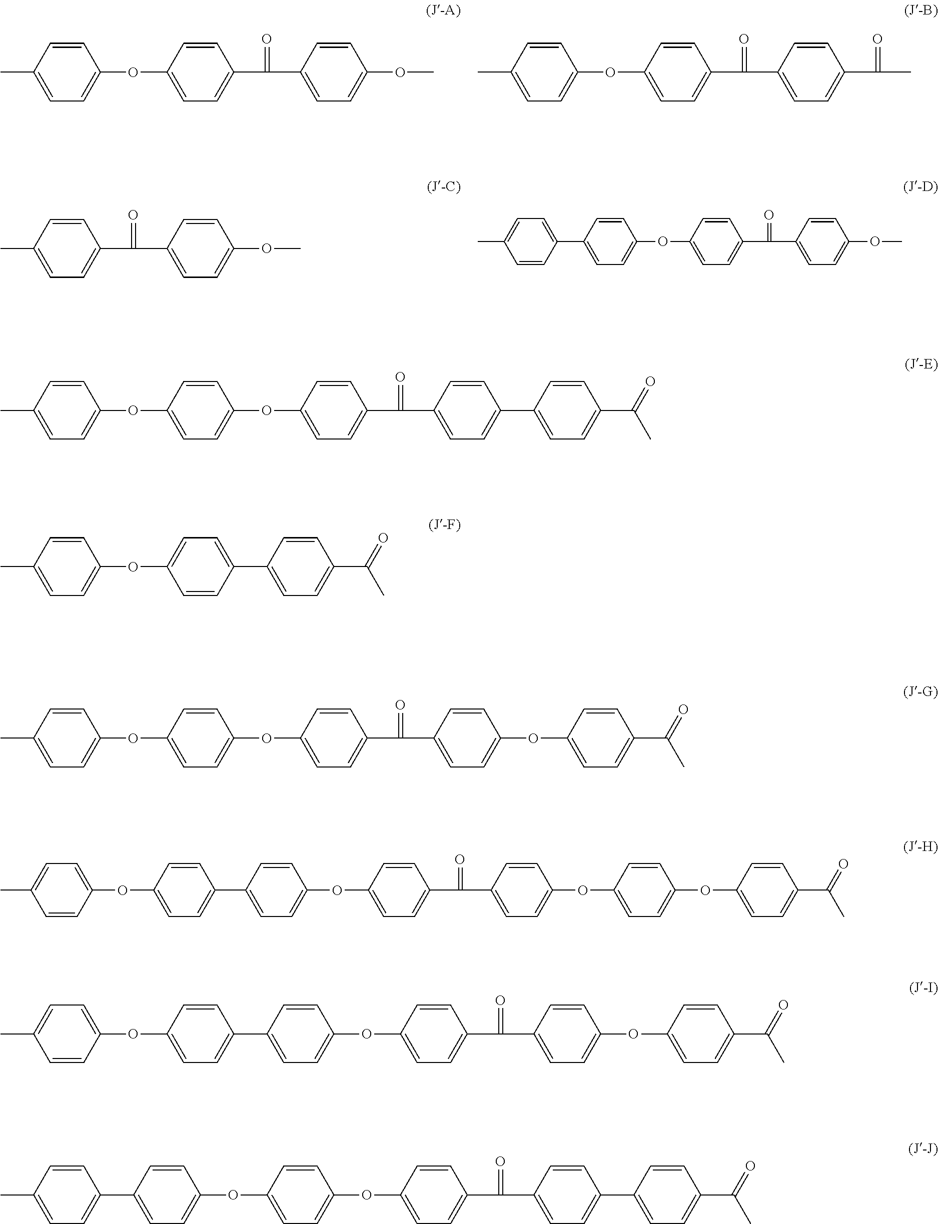

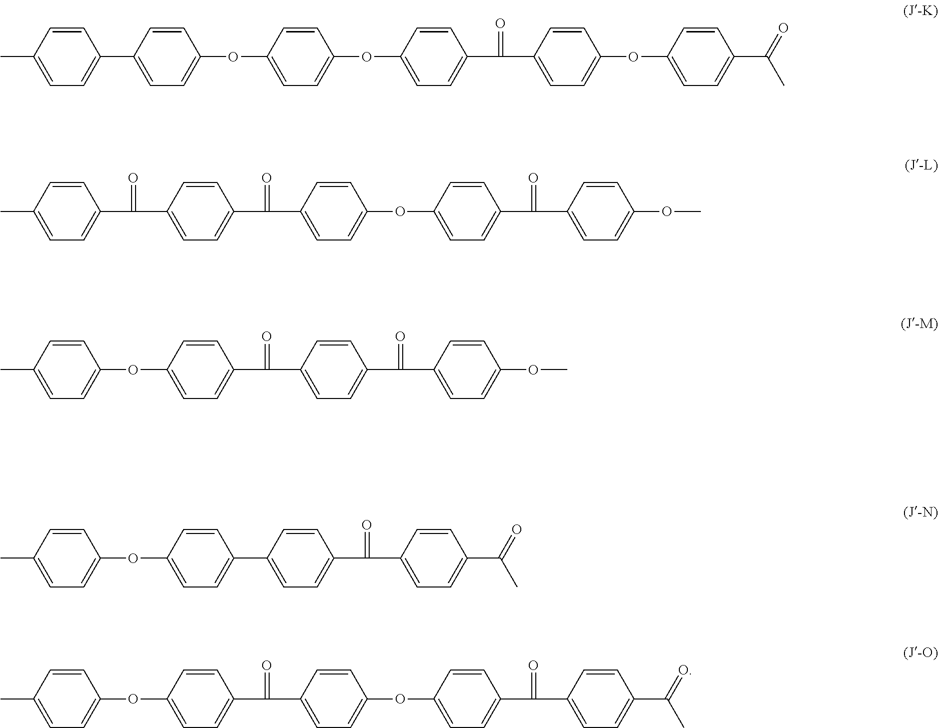

10. (canceled)

11. The wire of claim 1 wherein the polyaryletherketone polymer is a polyetheretherketone (“PEEK”) polymer.

12. (canceled)

13. The wire according to claim 3 wherein the polyarylethersulfone polymer (PAES polymer) is selected from the group consisting of PPSU, PES and PSU and wherein the PPSU, PES and PSU have more than:
at least 60 mol %
of recurring units (R_{PAES}) of respectively formula (B1), (B2), (B3): 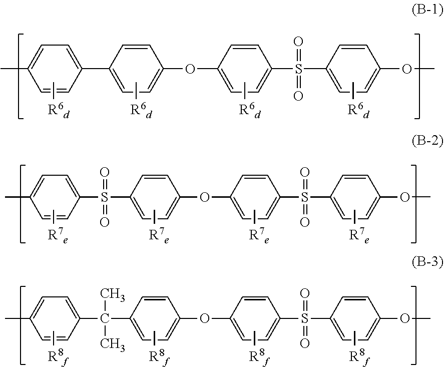
wherein d=e=f=0.

14. The wire according to claim 13 wherein;
the melt flow rate (MFR) of the PPSU as measured according to ASTM D1238 using a temperature of 365° C. and a 5.0 kg weight ranges from 5.0 to 45.0 g/10 min; or
the melt flow rate (MFR) of the PSU as measured according to ASTM D1238 using a temperature of 343° C. and a 2.16 kg weight ranges from 2.0 to 20.0 g/10 min.

15. (canceled)

16. The wire according to claim 3 wherein the amount of PAES polymer in the polymer composition ranges from 1.0 to 45.0 wt. %, based on the total weight of the PAEK and the PAES polymers in the composition.

17. (canceled)

18. The wire according to claim 1 wherein the talc exhibits a D50 between 0.5 and 10.0 μm, D50 being the median of a distribution (in volume) of the equivalent spherical diameters of the particles which is obtained by a sedimentation method.

19. (canceled)

20. (canceled)

21. (canceled)

22. The wire according to claim 2 wherein PEEK1 exhibits a viscosity higher than 300 Pa s, this viscosity being measured using a capillary rheometer with a die having dimensions of 0.5 mm diameter×3.175 mm length according to ASTM D3835 at 400° C. at a shear rate of 1,000 s⁻¹; and/or wherein PEEK2 exhibits a viscosity lower than 200 Pa s, this viscosity being measured using a capillary rheometer with a die having dimensions of 0.5 mm diameter×3.175 mm length according to ASTM D3835 at 400° C. at a shear rate of 1,000 s⁻¹; and/or wherein the weight ratio PEEK1/PEEK2 is between 50/50 and 70/30.

23. (canceled)

24. (canceled)

25. (canceled)

26. The wire of claim 1 wherein the composition has a melt viscosity of 250 to 500 Pa·s when measured according to ASTM D3835 at 400° C. and 1000 s⁻¹ with a capillary rheometer with a die having dimensions of 0.5 mm diameter×3.175 mm length.

27. (canceled)

28. (canceled)

29. (canceled)

30. The wire according to claim 1 wherein the composition exhibits a ratio r of viscosities between 5.0 and 10.0, r being defined as the ratio of the melt viscosity at 100 s-divided by the melt viscosity at 10000 s⁻¹, both viscosities being measured according to ASTM D3835 at 400° C. with a capillary rheometer with a die having dimensions of 0.5 mm diameter×3.175 mm length.

31. (canceled)

32. (canceled)

33. (canceled)

34. (canceled)

35. The wire according to claim 1 wherein the composition comprises from 10.0 to 26.0 wt. % of talc.

36. (canceled)

37. (canceled)

38. (canceled)

39. (canceled)

40. The wire according to claim 1 wherein the composition exhibits tensile elongation at break, as measured according to ASTM D638 (Type I specimen with 3.2 mm thickness, 50 mm/min) of at least 10.0%.

41. (canceled)

42. (canceled)

43. The wire of claim 1 wherein the wire is a magnet wire.

44. (canceled)

45. (canceled)

46. A method for making the wire of claim 1 comprising extruding a composition comprising at least one polyaryletherketone polymer and 6 to 40 wt. % of talc, with respect to the total weight of the composition, wherein said composition has a melt viscosity of at least 120 Pas, when measured according to ASTM D3835 at 400° C. and 1000 s⁻¹, to form the insulation layer.

47. The method of claim 46 wherein the insulation layer is formed directly on the conductor by extrusion coating.

48. The method of claim 46 wherein the insulation layer is extruded in the form of a tape and the method further comprises the steps of: providing a conductor, wrapping the insulation layer around the conductor; and heating to adhere the insulation layer to the conductor.

49. An electric machine comprising at least one wire according to claim 1.

50. A stator comprising the wire according to claim 1.

52. (canceled)
